(19) United States
(12) Patent Application Publication
(10) Pub. No.: US 2026/0283346 A1
(43) Pub. Date: Sep. 24, 2026

(54) A TABLE STRUCTURE

(71) Applicant: BAMBU GAMES YAZILIM SANAYI VE TICARET ANONIM SIRKETI, Nilüfer, Bursa (TR)

(72) Inventors: Halil Ibrahim YALNIZ, Nilüfer, Bursa (TR); Mehmet ÇAKMAK, Nilüfer, Bursa (TR)

(21) Appl. No.: 19/489,334

(22) PCT Filed: Oct. 13, 2023
(86) PCT No.: PCT/TR2023/051121

§ 371 Date: Dec. 2, 2025

(30) Foreign Application Priority Data
Jun. 14, 2023 (TR) 2023/007022

(51) Int. Cl. A47B 25/00; A47B 13/12; A47B 21/007; G07F 17/32

(52) U.S. Cl. CPC A47B 25/00; A47B 13/12; A47B 21/007; G07F 17/3241; A47B 2021/0076

(57) ABSTRACT

A method of creating custom image regions for users on a table that includes at least one integrated screen, and allows data input and generates audiovisual output with at least one touch panel, wherein at least one tray is provided to create the mentioned table, and predefined regions on the screen positioned on the tray are prevented from being viewed at different angles by individuals by using at least one filter placed on the regions, which is achieved by obstructing light transmission in at least one direction with a filter.

### FIELD OF THE INVENTION

The invention is related to a table that allows digital gaming to be played on it.

The invention is particularly related to a table structure that allows digital gaming to be played simultaneously by multiple users and can also be used as a standard table.

### PRIOR ART

Some games are played by one or more person in game rooms and homes. Especially games played by a team are physical games, where players sit around the same table and interact with each other through actions.

In today's world, individuals can play games in groups at game rooms, including card games, board games (such as Monopoly®, Taboo®, Risk®, etc.), as well as games that require special tables/areas like bowling and pool. With advancing technology, digital games are being developed as an alternative to physical games. These digital games can be played with limited users using mobile devices and are not highly preferred by multiple users. Furthermore, electronic gaming devices that support multiplayer gaming are limited to special gaming consoles (PlayStation®, Nintendo®, Xbox®, etc.).

In state-of-the-art board games can be played at home as well as being a popular choice in game rooms. However, a disadvantage of board games is their limited variety, and it is not always possible to access newly developed games.

In the known technology, applications that allow digital gaming with effects similar to physical games around the same table in a team are limited. Especially with the advancement of technology, certain needs arise, such as the ability to pause the game, team-specific recording and resumption, and protecting the game from physical effects during play. Additionally, presenting a digital game to the user with physical game-like effects is a solution that enhances the level of entertainment

In the known technology, it is not possible to ensure privacy in games played with multiple users and requiring privacy for each player. To address this issue, additional components such as screens to block the view may be needed. However, this solution does not create a comfortable experience for users. In the absence of such a solution, it may not be possible to play certain games

As a result, all abovementioned problems have made it necessary to make an improvement in the relevant technical field.

### AIM OF THE INVENTION

The present invention aims to eliminate the abovementioned problems and to make a development in the relevant technical field.

The main objective of the invention is to introduce a multi-purpose gaming table structure that allows users to play digital games together simultaneously with multiple users.

Another objective of the invention is to enable the gaming table to be used as a standard table.

Another objective of the invention is to allow users to charge their mobile devices on the gaming table.

Another objective of the invention is to offer users a variety of games from the same table.

Another objective of the invention is to prevent the wear and tear of games used in game rooms.

Another objective of the invention is to provide the home user with the possibility of using the table as both a coffee table and a gaming table.

### BRIEF DESCRIPTION OF THE INVENTION

The invention is related to a table structure, so as to fulfil all aims mentioned above and will be obtained from the following detailed description.

Within the scope of the invention, the control unit located on the table can install one or more games. These games can be presented to one or more users via the screen.

Interaction with the device can be achieved through a touch panel that allows multiple simultaneous touches. The most innovative aspect of the invention is that the screen and touch panel are positioned independently within the body. This provides ease of production and service. It is evident that the configuration of the invention can be used for various purposes regardless of size and dimension. Thanks to the filter module in the invention, in multiplayer games that can be played on gaming tables with designated screen area that is personalized for each user based on their sitting position. This allows for the creation of a private area for other users in situations where a player's privacy is required, such as in card games or tile games like “okey”. The filter only ensures that the user can see the relevant area and can optionally move it on the screen. In the preferred structure, when the user looks at the filter at a designated angle, they can see the image. This angle can be perpendicular to the filter or a different predefined angle.

Within the scope of the invention, the filter can filter light in at least two directions up to at least 45°. In the preferred structure, filtering is performed in four directions.

The invention relates a table that capable of producing audiovisual output that having at least one integrated screen, with at least one touch panel that allows data input that aligned parallel to said screen and separated by a gap from the screen; characterized in that, at least one tray to create the mentioned table at least one tray bottom plate that positioned at the lower part of the body inner opening to accommodate the screen on the mentioned tray; at least one filter module that includes at least one motion body which positioned on mentioned tray bottom plate which located under the screen; and at least one filter frame that aligned parallel to the screen that positioned the gap between the screen and the touch panel; at least one filter that associated with the mentioned filter frame, that filters the image in predefined regions; and at least one motion drive element to enable the filter to move in and out between the screen and the touch panel by allowing movement of the filter frame.

The invention relates a method of creating custom image regions for users on a table that includes at least one integrated screen, and allows data input and generates audiovisual output characterized by the following feature: includes at least one tray to create the mentioned table and the predefined regions on the screen which positioned on the tray are prevented from being viewed at different angles by individuals by using at least one filter placed on the mentioned regions, that achieved by obstructing the light transmission in at least one direction with the mentioned filter.

In another preferred embodiment of the invention, it is characterized by, the filter that can move linearly over predefined regions especially between the screen and the touch panel that allows data input.

In another preferred embodiment of the invention, it is characterized by, the filter that filters the light on the screen at least at a 270° angle to prevent the viewing of the relevant region by individuals sitting at different edges of the table

In another preferred embodiment of the invention, it is characterized by, the filter that filters the light on the screen at least at a 360° angle to prevent the viewing of the relevant region by individuals sitting at different edges of the table

In the preferred configuration, the filter is a ghost screen, which can refract light.

In another preferred embodiment of the invention it comprises, a frame positioning element that enables the filter and the filter frame to be moved on the screen.

In another preferred embodiment of the invention it comprises, a frame body and a frame positioning element that extends vertically from the frame body on the vertical axis to ensure the transfer of the motion from occurring in the motion body that located in the lower part of the screen to the filter and filter frame that aligned in the upper part of the screen.

In another preferred embodiment of the invention, it is characterized by, the motion body includes a motion sliding car that connected to the frame body to enable linear motion of the frame body; and a sliding rail that allows movement of the mentioned motion sliding car.

In another preferred embodiment of the invention, it is characterized by, to enable the movement of the mentioned filter, it includes a motion drive element, which is at least one threaded spindle that moves the frame body that associated with the mentioned motion drive element; and a drive element that fixed to the frame body.

In another preferred embodiment of the invention it comprises, at least one motor that connected to the motion body to facilitate the rotation of mentioned motion drive element, which has threaded spindle.

The mentioned motor is preferably a stepper motor and it is controlled by the control unit.

In another preferred embodiment of the invention it comprises, at least one motor fixing element to secure mentioned motor body on the motion body.

In another preferred embodiment of the invention, it is characterized by, the motion body that is integral with the tray bottom plate.

In another preferred embodiment of the invention it comprises, the tray upper plate on the touch panel.

In another preferred embodiment of the invention, it includes a tray upper plate that made of durable plexiglass material, which can transfer touch when in contact with it to the touch panel, is partially light-permeable, and thereby allows the observation of the image on the screen while being resistant to impact. In an alternative configuration, tempered glass is used that can transfer capacitive touch.

In another preferred embodiment of the invention, it includes a covering that aligned with the screen around the edges of the upper plate to prevent light transmission and to hide the components of the filter module. In this context, the section aligned with the screen is transparent, with the outer part having a non-light-permeable covering at the level of the tray body.

In alternative configurations of the invention, it is possible to use a stationary filter in contact with the tray upper plate.

In another preferred embodiment of the invention, it includes a control unit with at least one operating system that enables the transfer of images to the panel on the screen.

In another preferred embodiment of the invention, it includes an integrated control unit on the same module with the screen.

In another preferred embodiment of the invention, it includes at least one cooling element in contact with the tray bottom plate to cool the components located within the body inner opening.

In another preferred embodiment of the invention, the cooling element, which is a fan, includes at least one cooling opening on the tray bottom plate to facilitate air circulation within the body inner opening.

In another preferred embodiment of the invention, the mentioned cooling opening is positioned on the outside of the tray bottom plate and includes a cooling enclosure that allows airflow and protects the cooling element from physical damage in this area.

In another preferred embodiment of the invention, it includes at least one touch panel connection unit that located on the touch panel to enable the touch panel to transmit data to the control unit. The mentioned connection unit can be guided through a bracket consisting of at least one piece.

In another preferred embodiment of the invention, it includes at least one leg connection opening on the tray bottom plate to establish alignment with the void within the leg that contains a void inside.

In another preferred embodiment of the invention, it includes a base support sheet made up of at least one part in contact with the leg that support the leg on the floor.

In another preferred embodiment of the invention, it includes at least one cable channel that located on the base support sheet to allow at least one cable extending from the opening inside the leg to be taken outside.

In another preferred embodiment of the invention, it includes a channel cover that consisting of at least one part that can be attached and removed in the region to facilitate the closure of the mentioned cable channel.

In another preferred embodiment of the invention, it includes at least one wireless charging unit that positioned on the tray body to enable the charging of wireless charging-compatible mobile devices that placed on the table.

In another preferred embodiment of the invention, it includes at least one lighting unit that positioned on the edge of the tray body to illuminate the edges of the table.

In another preferred embodiment of the invention, it includes at least one communication unit inside the tray body to enable communication between the mentioned control unit and external devices.

In another preferred embodiment of the invention, it includes a communication unit which is 4G/5G module.

In another preferred embodiment of the invention, it includes a communication unit which is an ethernet module.

In another preferred embodiment of the invention, it includes a communication unit which is a Wi-Fi module.

In another preferred embodiment of the invention, it includes a tray bottom plate that made of metal material.

In another preferred embodiment of the invention, it includes a tray bottom plate that made of sheet metal material.

In another preferred embodiment of the invention, it includes a tray body that made of wood material.

In another preferred embodiment of the invention, it includes a leg that made of metal material.

In another preferred embodiment of the invention, it includes a lighting unit with a light guide powered by a light source positioned inside the tray body.

The protection scope of the invention is specified in the claims and cannot be limited to the description made for illustrative purposes in this brief and detailed description. It is clear that a person skilled in the art can present similar embodiments in the light of the above descriptions without departing from the main theme of the invention.

### BRIEF DESCRIPTION OF DRAWINGS

FIG. 1 provides a perspective view of the invention.

FIG. 2 provides a side view drawing of the components of the invention.

FIG. 3 provides a top view drawing of the components of the invention.

FIG. 4 provides another perspective drawing of the components of the invention.

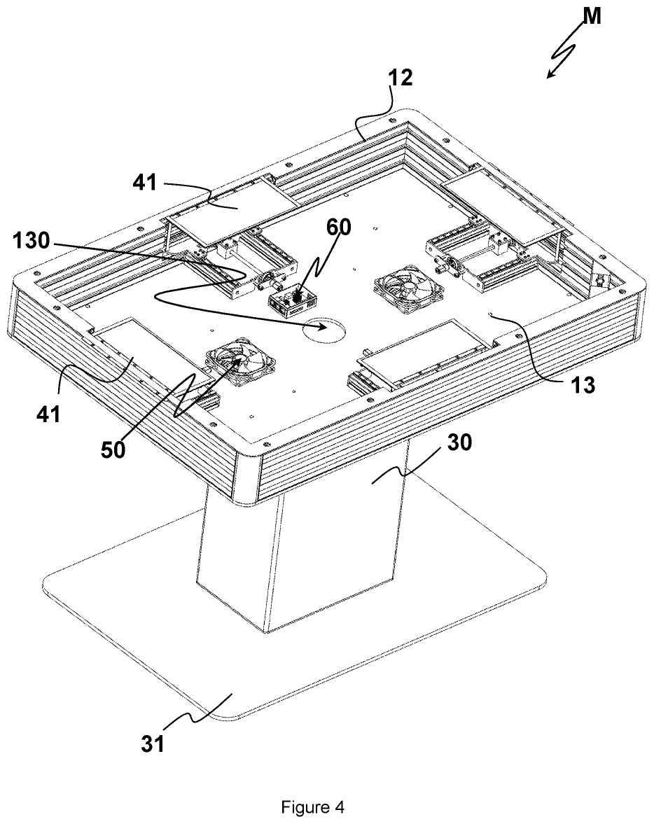

FIG. 5 provides a perspective drawing of the filter module of the invention.

FIG. 6 provides a side view drawing of the filter module of the invention.

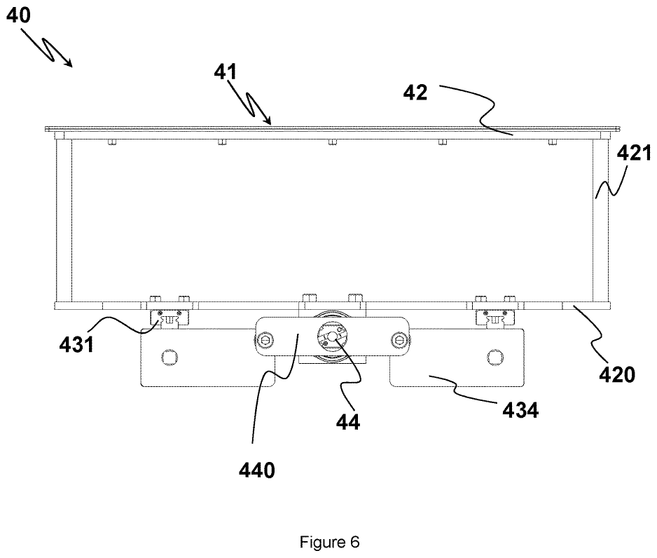

FIG. 7 provides a side view drawing of the filter module of the invention.

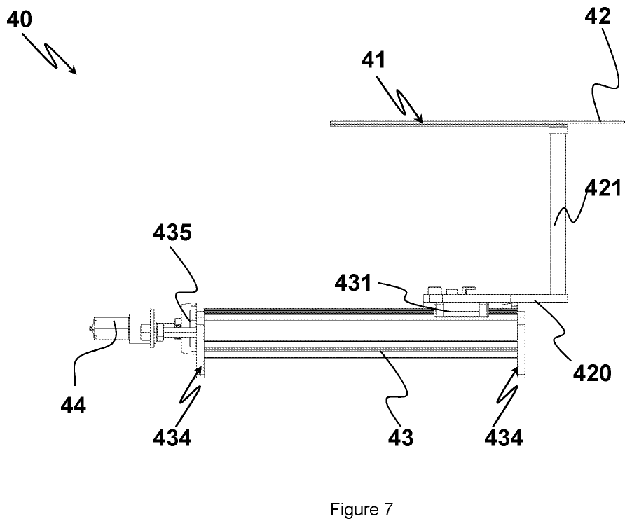

The drawings do not necessarily need to be scaled and some details that are not necessary to understand the present invention may have been omitted. In addition, elements that are at least largely identical or at least largely have identical functions are indicated with the same number.

DESCRIPTION OF THE REFERENCES IN FIGURES

10. Tray
100. Tray body
101. Body inner opening
11. Lightning unit
12. Tray upper plate
121. Covering
13. Tray bottom plate
130. Bottom opening
14. Touch panel
20. Screen
21. Screen body
30. Leg
31. Base support sheet
40. Filter module
41. Filter
42. Filter frame
420. Frame body
421. Frame positioning element
43. Motion body
430. Motion sliding car
431. Sliding rail
432. Motion drive element
433. Drive element
434. Body connection element
435. Bearing element
44. Motor
440. Motor fixing element
50. Cooling element
60. Control unit
M. Table

### DETAILED DESCRIPTION OF THE INVENTION

In this detailed description, the invention a table (M) structure is described by means of examples only for clarifying the subject matter such that no limiting effect is created.

The invention is particularly related to a table structure that allows digital gaming to be played simultaneously by multiple users and can also be used as a standard table (M).

The invention relates a table (M) that capable of producing audiovisual output that having at least one integrated screen (20), with at least one touch panel (14) that allows data input that aligned parallel to said screen (20) and separated by a gap from the screen (20); characterized in that, at least one tray (10) to create the mentioned table (M); at least one tray bottom plate (13) that positioned at the lower part of the body inner opening (101) to accommodate the screen (20) on the mentioned tray (10); at least one filter module (40) that includes at least one motion body (43) which positioned on mentioned tray bottom plate (13) which located under the screen (20); and at least one filter frame (42) that aligned parallel to the screen (20) that positioned the gap between the screen (20) and the touch panel (14); at least one filter (41) that associated with the mentioned filter frame (42), that filters the image in predefined regions; and at least one motion drive element (432) to enable the filter (41) to move in and out between the screen (20) and the touch panel (14) by allowing movement of the filter frame (42).

The invention relates a method of creating custom image regions for users on a table (M) that includes at least one integrated screen (20), and allows data input and generates audiovisual output characterized by the following feature: includes at least one tray (10) to create the mentioned table (M), and the predefined regions on the screen (20) which positioned on the tray (10) are prevented from being viewed at different angles by individuals by using at least one filter (41) placed on the mentioned regions, that achieved by obstructing the light transmission in at least one direction with the mentioned filter (41).

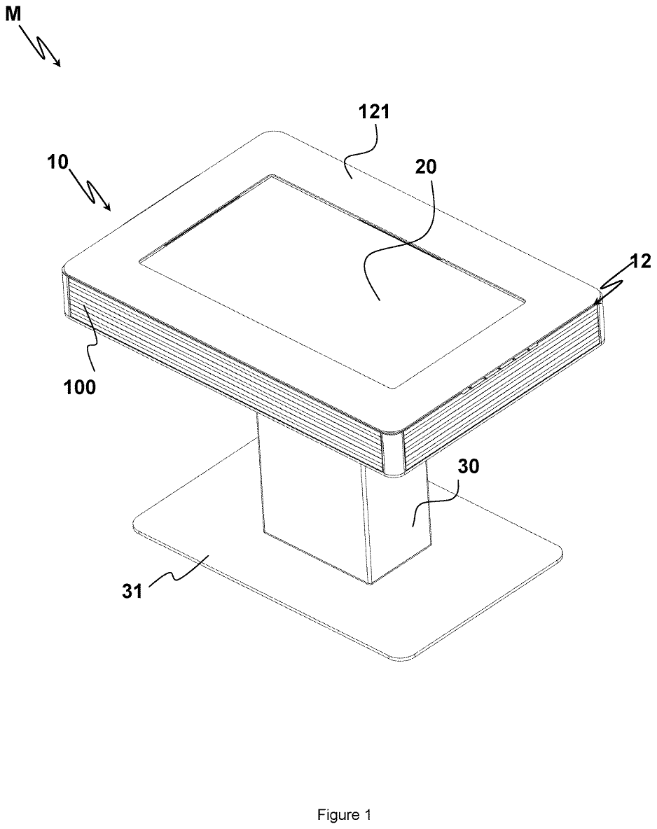

A perspective drawing of the invention is provided in FIG. 1. The subject of the invention, the table (M), has at least one tray (10) in the upper part and at least one leg (30) in the lower part. The mentioned tray (10) is positioned on at least one leg (30). In another preferred embodiment of the invention, it includes two legs (30). The mentioned leg (30) is in contact with at least one base support sheet (31) in the lower part. Mentioned base support sheet (31) ensures an equal and balanced distribution of the weight of the tray (10) to the ground, allowing the table (M) to be positioned smoothly and evenly. The legs (30) which included by the invention are preferably made of metal material and can be secured from the leg connection opening section on the tray bottom plate (13).

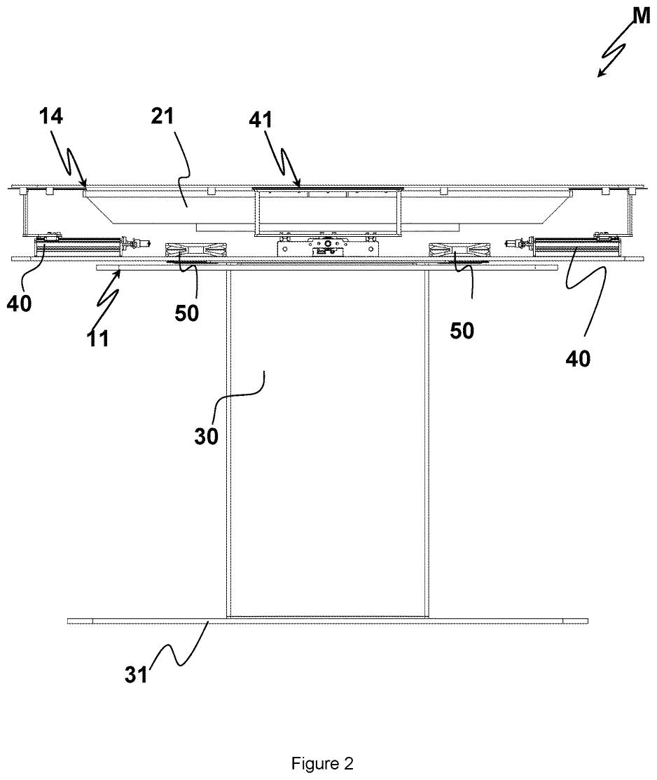

A side view is provided in FIG. 2, which is showing the components inside the tray body (100) of the table (M). The table (M) has a tray (10) that consists of at least one-piece tray body (100). The mentioned tray body (100) contains a body inner opening (101) in its central part. Within the said body inner opening (101), a screen (20), at least one filter module (40), and a control unit (60) are positioned. A touch panel (14) is located at the upper part of the mentioned body inner opening (101).

The invention includes a tray bottom plate (13) at the lower part of the tray body (100). The mentioned tray bottom plate (13) covers the lower part of the body inner opening (101). In the preferred embodiment, the mentioned tray bottom plate (13) is made of metal material. Within the scope of the invention, the screen (20) is positioned on the mentioned tray bottom plate (13), and the touch panel (14) is located at the upper part of the screen (20). The control unit (60) can be integrated with the screen (20) module or positioned independently within the tray (10). A tray upper plate (12) is located at the topmost part of the tray (10).

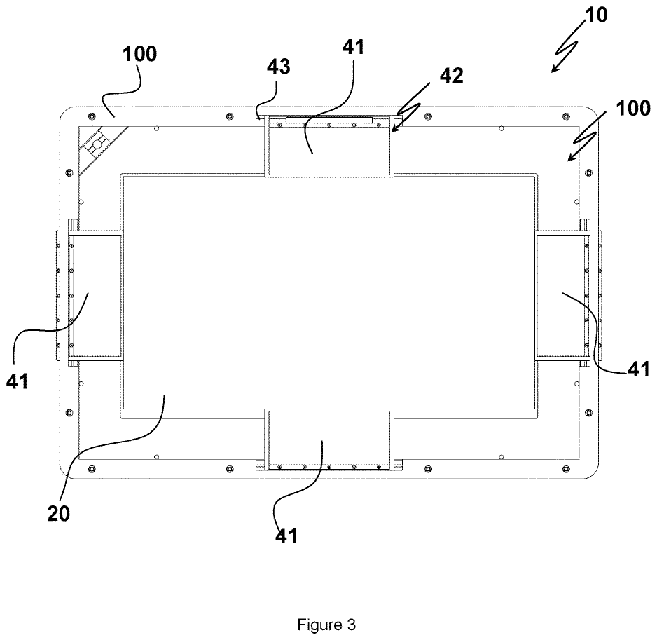

Within the scope of the invention, a filter module (40) is present on the edges of the tray (10) to filter a portion of the screen (20). A drawing is provided in FIG. 3, that shows the positions of the filter modules (41) on the table (M). In the preferred embodiment, there is at least one filter module (40) on each edge of the table (M). The mentioned filter module (40) includes a filter (41) that prevents users from seeing a portion in front of another user in multiplayer games. In the preferred embodiment, the mentioned filter (41) can block light at an angle of at least 270°, and it prevents the image in the relevant area from being visible from the front and both sides. In another preferred embodiment, the mentioned filter (41) can filter from 360°. With this embodiment, the user can see the relevant portion when looks at the screen in a nearly perpendicular position.

Thanks to the mentioned filter module (40), the filter (41) is positioned between the screen (20) and the touch panel (14) and can be aligned with the covering (121) section on the screen or the outer part of the screen by moving linearly at least in one axis.

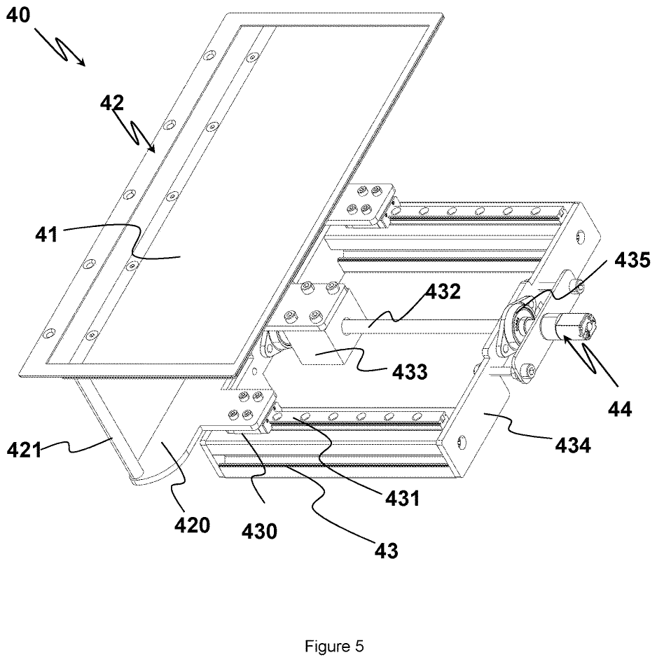

A perspective drawing of the filter module (40) of the invention is provided in FIG. 5. The filter module (40) includes at least one motion body (43) and it can be secured onto the tray bottom plate (13) through the mentioned motion body (43). The filter (41) is connected to the motion body (43) via a filter frame (42) that consisting of at least one part. The filter (41) is positioned higher than the motion body (43) through the filter frame (42) and it is connected to the motion body (43) via a frame positioning element (421) that attaches the filter frame (42) to the motion body (43). This allows the motion body (43) and the filter (41) can be aligned parallel to each other, and the screen (20) is aligned with the opening between them. The filter frame (42) encloses the filter (41) and is connected to the motion body (43) via the frame body (420). The mentioned frame body (420) can move linearly on the motion body (43).

Within the scope of the invention, there is a sliding rail (431) that positioned between the motion body (43) and the frame body (420), and the movement of the filter frame (42) is preferably accomplished with at least one motion drive element (432). The mentioned motion drive element (432) is connected to the frame body (420) via at least one drive element (433).

In the preferred embodiment, at least one motion sliding car (430) is positioned on the frame body (420), and linear motion is achieved on the sliding rail (431).

The motion body (43) which is included by the invention is preferably created by at least two profiles positioned parallel to each other and at least one, preferably two, body connection elements (434) that ensure the connection of these profiles to each other. In alternative embodiments, it is possible to manufacture the motion body (43) from one or more parts produced using machining techniques, and the structure of the sliding rail (431) can also be integrated with mentioned motion body (43).

The motion drive element (432) used in the invention is a threaded rod. The mentioned threaded rod is connected to the motion body (43) through at least one, preferably two, bearing elements (435). The threaded rod is rotated by at least one motor (44), and the drive element (433) with a toothed structure on it, which is held in a fixed axis through the frame body (420), can move linearly. In alternative embodiments of the invention, usage of alternative sliding structures that can move linearly directly with electrical energy is possible.

The motor (44) included in the invention is preferably a stepper motor (44). The mentioned motor (44) is connected to the motion body (43) preferably on the body connection element (434), through a motor fixing element (440).

The filter (41) can be positioned between the screen (20) and the touch panel (14) in parallel to the screen (20) through the filter module (40). While the filter body (43) is located under the screen (20) or the screen body (21), the filter (41) can be positioned on the screen (20). The mentioned motion course can vary depending on the length of the motion body (43) and, consequently, the length of other components.

In one of the preferred embodiment of the invention, it includes at least one control unit (60) that integrated with or independent of the screen (20) panel. Within the scope of the invention, an independent control unit (60) is used separate from the screen. The control unit (60) includes an operating system and can have the desired game or application installed on this operating system. The mentioned control unit (60) is preferably a Raspberry Pi.

The tray bottom plate (13) included in the tray (10) is preferably made of sheet metal material and has openings to provide access to the screen (20) and other components that located in the body inner opening (101) and it performs cooling of these components. Cables can be routed into the leg (30) through the bottom opening (130) that located in the relevant area. There is at least one cooling opening on the tray bottom plate (13). The mentioned cooling openings allow the cooling of components through alignment with a cooling element (50).

The cooling element (50) is positioned in mentioned cooling opening, preferably on the side of the body inner opening (101). In the preferred embodiment, the mentioned cooling element (50) is a fan. In an alternative embodiment, a fan in combination with a heat sink (cooling metal) is can be usable.

FIG. 2 provides a drawing that shows the configuration on the tray bottom plate (13). To protect the cooling elements (50) on the outer part of the tray bottom plate (13) from external physical effects, there is at least one cooling enclosure that allows the closure of these cooling openings. The mentioned cooling enclosure is preferably in the form of a grid/grille shaped and made of metal material and has a cover structure that allows air passage.

In the preferred embodiment of the invention, there are two cooling openings on the tray bottom plate (13). In an alternative embodiment, it is possible to use an opening and cooling element (50) structure that allows the dissipation of heat from the inside to the outside. In another alternative embodiment, the air flow direction of the cooling elements (50) can be configured in opposite directions. Thereby enabling the cooling of the body inner opening (101) inside.

As seen in FIG. 2, there is a lighting unit (11) surrounding the entire perimeter or a portion of the tray body (100). The mentioned lighting unit (11) can be an LED group positioned in a channel created in the relevant area or it can be a light guide. The lighting unit (11) is preferably controllable through selections which made on the screen (20). In alternative embodiments, different types of lighting units (11) can be used.

Under the tray upper plate (12) of the table (M), preferably in at least one corner of the table (M), there is a wireless charging unit. With the mentioned wireless charging unit, users can charge their mobile devices by placing them on the table (M).

The touch panel (14) that included by the invention is aligned with the screen (20) and is positioned on the tray (10), preferably over the tray body (100). On the touch panel (14), there is a touch panel connection unit. The mentioned touch connection unit is directly connected to the control unit (60) and can be used for data input.

The touch panel (14) that included by the invention, has capacitive feature and allows for simultaneous detection of more than one data input/touch. This enables simultaneous collaborative gameplay with multiple users.

The control unit (60) that included by the invention has at least one communication module. The mentioned communication module allows for Wi-Fi connection and/or 4G/5G communication. Additionally, data transfer is possible via a USB module.

In the preferred embodiment of the invention, the control unit (60) is integrated with the screen (20) module and they can be positioned together.

In the preferred embodiment of the invention, the screen (20) can be a Smart TV panel and module. The touch panel (14) is an external module that independent of the screen (20).

The tray upper plate (12) in the invention includes non-translucent covering (121) at the edges. This ensures that the top of the table (M) has a decorative appearance and prevents light leakage from the edge of the screen (20) into the table body (100). Additionally, a decorative area is created around the screen (20), that prevents the components that located in the body inner opening (101) from being visible.

In a preferred embodiment of the invention, a sealing element is used between the tray upper plate (12) and the tray body (100). The sealing element can be a watertight gasket or glass adhesive sealant.

In another preferred embodiment of the invention, the covering (121) around the tray upper plate (12) is made of plexiglass material.

In the preferred embodiment of the invention, the tray upper plate (12) is made of tempered glass, while the tray body (100), tray bottom plate (13), legs (30), and base support sheet (31) are made of metal, preferably aluminum material.

The table (M) is equipped with a wireless charging unit, preferably located in at least one corner of the tray upper plate (12). With this wireless charging unit, users can charge their mobile devices by simply placing them on the table (M).

In the preferred embodiment of the invention, the components within the table (M) receive power from at least one power unit.

In another preferred embodiment of the invention, the table (M) includes at least one holder in the edge portion of its tray (10). This holder allows for the placement of cups, and in alternative applications, it enables the hanging of items.

1. A table that is capable of producing audiovisual output, the table comprising:
at least one tray to create said table, and predefined regions on at least one integrated screen which positioned on the tray are prevented from being viewed at different angles by individuals by using at least one filter placed on said regions, which is achieved by obstructing the light transmission in at least one direction with said filter;
wherein the at least one integrated screen is provided with at least one touch panel that allows data input that aligned parallel to said screen and separated by a gap from the screen;
wherein the filter can move linearly over predefined regions especially between the screen and the touch panel that allows data input;
at least one tray bottom plate that positioned at the lower part of the body inner opening to accommodate the screen on said tray;
at least one filter module that includes at least one motion body which is positioned on mentioned said tray bottom plate which is located under the screen;
at least one filter frame that is aligned parallel to the screen that positioned the gap between the screen and the touch panel;
wherein the at least one filter associated with the mentioned filter frame filters the image in predefined regions that produced from screen; and
at least one motion drive element to enable the filter to move in and out between the screen and the touch panel by allowing movement of the filter frame.

2. The table of claim 1, wherein the filter filters the light on the screen at least at a 270° angle to prevent the viewing of the relevant region by individuals sitting at different edges of the table.

3. The table of claim 1, wherein the filter filters the light on the screen at least at a 360° angle to prevent the viewing of the relevant region by individuals sitting at different edges of the table.

4. The table of claim 1, comprising a frame positioning element that enables the filter and the filter frame to be moved on the screen.

5. The table of claim 4, comprising a frame body and a frame positioning element that extends vertically from the frame body on the vertical axis to ensure the transfer of the motion from occurring in the motion body that located in the lower part of the screen to the filter and filter frame that aligned in the upper part of the screen.

6. The table of claim 1, wherein the motion body includes a motion sliding car that is connected to the frame body to enable linear motion of the frame body; and a sliding rail that allows movement of the mentioned motion sliding car.

7. The table of claim 6, wherein to enable the movement of the mentioned filter, it includes a motion drive element, which is at least one threaded spindle, that moves the frame body that associated with the mentioned motion drive element; and a drive element that fixed to the frame body.

8. The table of claim 6, comprising at least one motor that is connected to the motion body to facilitate the rotation of mentioned motion drive element, which has a threaded spindle.

9. The table of claim 8, comprising at least one motor fixing element to secure said motor body on the motion body.

10. The table of claim 1, wherein the motion body is integral with the tray bottom plate.

11. The table of claim 1, comprising a tray upper plate on the touch panel.

12. The table of claim 11, wherein the tray upper plate that is made from tempered glass.

13. The table of claim 11, comprising a covering that is located on the edges of the upper plate that is aligned with a round of the screen to prevent light transmission and to hide the components of the filter module.
